(19) United States
(12) Patent Application Publication
(10) Pub. No.: US 2017/0059419 A1
(43) Pub. Date: Mar. 2, 2017

(54) PIEZOCAPACITIVE TYPE PRESSURE SENSOR WITH POROUS DIELECTRIC LAYER

(71) Applicant: KOREA ADVANCED INSTITUTE OF SCIENCE AND TECHNOLOGY, Daejeon (KR)

(72) Inventors: In Kyu PARK, Daejeon (KR); Dong Uk KWON, Daejeon (KR)

(73) Assignee: KOREA ADVANCED INSTITUTE OF SCIENCE AND TECHNOLOGY, Daejeon (KR)

(21) Appl. No.: 14/990,838

(22) Filed: Jan. 8, 2016

(30) Foreign Application Priority Data
Sep. 2, 2015 (KR) 10-2015-0124360

(51) Int. Cl. G01L 1/14

(52) U.S. Cl. CPC G01L 1/142

(57) ABSTRACT

According to the present disclosure, there is provided a piezocapacitive type pressure sensor including a first electrode layer, a second electrode layer spaced apart from the first electrode layer, and a dielectric layer formed between the first electrode layer and the second electrode layer, wherein the dielectric layer is made of a porous elastomer.

### CROSS-REFERENCE TO RELATED APPLICATIONS

This application claims priority under 35 U.S.C. §119 to Korean Patent Application No. 10-2015-0124360, filed on Sep. 2, 2015, in the Korean Intellectual Property Office, the disclosure of which is incorporated herein by reference in its entirety.

### SPECIFIC REFERENCE TO A GRACE PERIOD INVENTOR DISCLOSURE

This invention has been published in the 17^{th} Korea MEMS Conference (Publication Date: Sep. 22, 2014), 40^{th} Micro and Nano Engineering 2014 (Publication Date: Apr. 2, 2015), and Korean Sensor Conference (Publication Date: Nov. 14, 2014).

### TECHNICAL FIELD

The present disclosure relates to a piezocapacitive type pressure sensor, and more particularly, to a piezocapacitive type flexible pressure sensor using a porous elastomer as a dielectric layer.

### BACKGROUND

Pressure sensors are largely classified into mechanical pressure sensors using elastic repulsion of a spring element against the external pressure, and electrical pressure sensors using changes in electrical response characteristics of a sensing unit against the external pressure.

Electrical pressure sensors include, for example, piezoelectric pressure sensors, piezoresistive pressure sensors, and capacitive type pressure sensors, and capacitive type pressure sensors having a dielectric layer formed between two parallel electrode layers make use of changes in capacitance with the changing distance between the two electrode layers in response to the compression of the dielectric layer against the external pressure, and they can measure both dynamic and static external pressure accurately and are being used the most widely in recent years.

Elastomer with superior compression and recovery can be used as a dielectric layer for capacitive type pressure sensors, and the pressure range in which the pressure sensors can operate is determined according to the compression characteristics of elastomer. Traditional elastomer-based capacitive type pressure sensors have failed to provide the practicable level of resolution and sensitivity on relatively fine scale pressure level within the operable pressure range, resulting in low industrial applications.

### RELATED LITERATURES

### Patent Literatures

(Patent Literature 1) Korean Patent No. 10-1259782 (May 3, 2013)

(Patent Literature 2) Korean Patent Publication No. 10-2005-0084524 (Aug. 26, 2005)

(Patent Literature 3) Korean Patent Publication No. 10-2005-0019885 (Mar. 3, 2005)

(Patent Literature 4) US Patent Publication No. 2014/0104047 A1 (Apr. 17, 2014)

(Patent Literature 5) US Patent Publication No. 2004/0231969 A1 (Nov. 25, 2004)

(Patent Literature 6) Japanese Patent Publication No. 2007-268333 (Oct. 18, 2007)

(Patent Literature 7) Japanese Patent Publication No. 61-207939 (Sep. 16, 1986)

### SUMMARY

The present disclosure is directed to providing a piezocapacitive type pressure sensor that can stably measure the pressure in a wider pressure range than a traditional capacitive type pressure sensor while maintaining high sensitivity.

The present disclosure is further directed to providing a piezocapacitive type pressure sensor that can measure the pressure on fine scale pressure level with high sensitivity.

To achieve the above objects of the present disclosure, according to one aspect of the present disclosure, there is provided a piezocapacitive type pressure sensor including a first electrode layer, a second electrode layer spaced apart from the first electrode layer, and a dielectric layer formed between the first electrode layer and the second electrode layer, wherein the dielectric layer is made of a porous elastomer.

The first electrode layer may have a first base made of a flexible electrically insulating material, and a first electrode pattern made of an electrically conducting material formed on one surface of the first base, and the second electrode layer may have a second base made of a flexible electrically insulating material, and a second electrode pattern made of an electrically conducting material formed on one surface of the second base, facing the first electrode pattern.

The first base and the second base may be made of an elastomer.

The first electrode pattern and the second electrode pattern may be made up of carbon nanotube bundles as a conducting material.

The dielectric layer may have porosity of from 60% to 80% according to the porosity of a template.

The objects of the present disclosure previously mentioned can be all achieved by the present disclosure. Specifically, because a porous elastomer is used as a dielectric layer, the distance between two electrode layers greatly changes even at a smaller force, resulting in significantly improved sensitivity. Also, because a porous elastomer is used as a dielectric layer, the effective dielectric constant value increases when micropores are closed by the external pressure, and as a result, a larger change of capacitance value is induced and the sensitivity of the sensor is further improved.

### BRIEF DESCRIPTION OF THE DRAWINGS

FIG. 1 is a schematic perspective view of a piezocapacitive type pressure sensor according to an embodiment of the present disclosure.

FIG. 2 is a perspective view of each layer, as separated, of the piezocapacitive type pressure sensor of FIG. 1.

FIG. 3 is a diagram illustrating an example of a process of producing a dielectric layer in the piezocapacitive type pressure sensor of FIG. 1.

FIG. 4 is a diagram illustrating an example of a process of producing an electrode layer in the piezocapacitive type pressure sensor of FIG. 1.

FIGS. 5 through 7 are photographic images showing three cross sections of a first sample for a dielectric layer of the piezocapacitive type pressure sensor of FIG. 1.

FIGS. 8 through 10 are photographic images showing three cross sections of a second sample for a dielectric layer of the piezocapacitive type pressure sensor of FIG. 1.

FIGS. 11 and 12 are cross-sectional views conceptually illustrating a cross-sectional structure of the piezocapacitive type pressure sensor of FIG. 1; FIG. 11 shows a state under no external pressure applied, and FIG. 12 shows a compressed state under the external pressure applied.

FIG. 13 is a graph showing a comparison of pressure sensing performance between the piezocapacitive type pressure sensor of FIG. 1 and a pressure sensor according to comparative example.

FIG. 14 is a graph showing reliability test results for a piezocapacitive type pressure sensor according to the present disclosure.

FIG. 15 is a graph showing dynamic pressure response characteristics of a piezocapacitive type pressure sensor according to the present disclosure.

FIG. 16 is a graph showing dynamic response characteristics as a function of frequency for a piezocapacitive type pressure sensor according to the present disclosure.

### DETAILED DESCRIPTION OF MAIN ELEMENTS

100: Piezocapacitive type pressure sensor
110: First electrode layer
120: Second electrode layer
130: Porous elastomer dielectric layer
131: Micropore

### DETAILED DESCRIPTION OF EMBODIMENTS

Hereinafter, elements and operations of the preferred embodiments of the present disclosure are described in detail with the accompanying drawings.

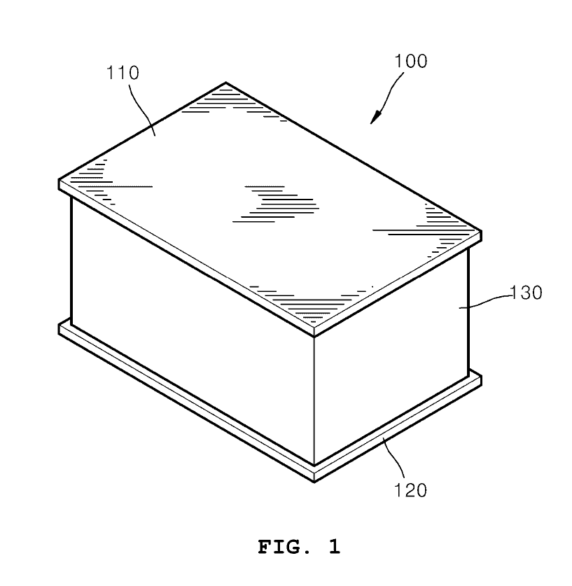

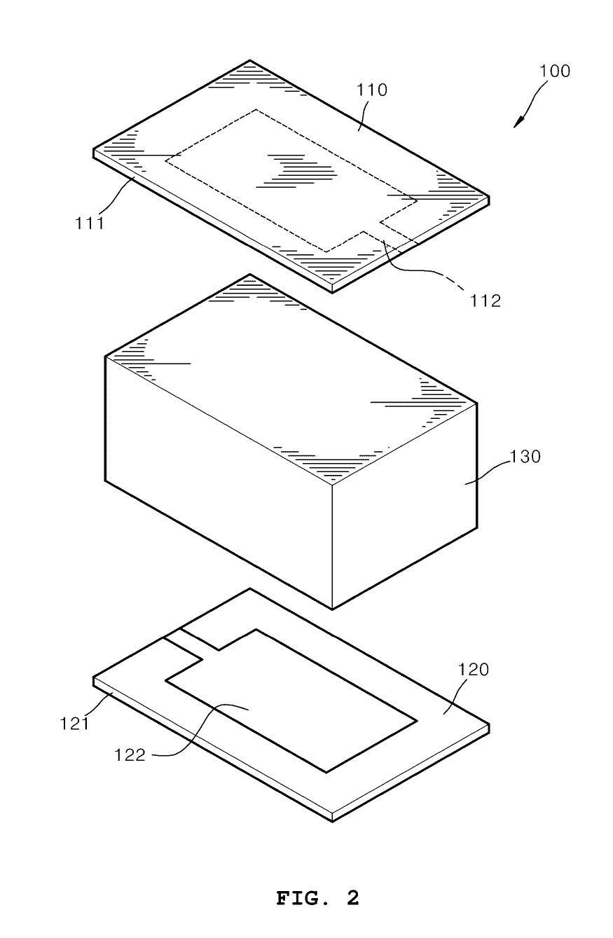

FIG. 1 is a schematic perspective view of a piezocapacitive type pressure sensor according to an embodiment of the present disclosure, and FIG. 2 is a perspective view of each layer, as separated, of the piezocapacitive type pressure sensor of FIG. 1. Referring to FIGS. 1 and 2, the piezocapacitive type pressure sensor 100 according to an embodiment of the present disclosure includes a first electrode layer 110, a second electrode layer 120 spaced apart from the first electrode layer 110, and a dielectric layer 130 made of a porous elastomer, interposed between the two electrode layers 110 and 120. Because the piezocapacitive type pressure sensor 100 uses a porous elastomer as the dielectric layer, the pressure can be measured with much higher sensitivity in a wider pressure range than traditional elastomer-based capacitive type pressure sensors.

The first electrode layer 110 has a flexible property, and has a first base 111, and a first electrode pattern 112 formed on one surface of the first base 111.

The first base 111 is in the form of a thin film of an electrically insulating material and is made of a flexible material having elasticity, so the first base 111 is easily deformed by the external pressure and restores to the original shape when the external pressure is removed. The first base 111 structurally supports the first electrode pattern 112. Although this embodiment describes that the first base 111 is made of elastomer, the present disclosure is not limited thereto.

The first electrode pattern 112 is formed from an electrically conducting material on one surface of the first base 111. Although this embodiment describes that the first electrode pattern 112 is made up of carbon nanotube bundles, the present disclosure is not limited thereto.

The second electrode layer 120 has a flexible property, and has a second base 121, and a second electrode pattern 122 formed on one surface of the second base 121. Because a specific configuration of the second electrode layer 120 is generally the same as the first electrode layer 110, its detailed description is omitted herein. The second electrode pattern 122 faces the first electrode pattern 112 of the first electrode layer 110 with a dielectric layer 130 interposed between. Basically, when the dielectric layer 130 is compressed by the external pressure applied to the two electrode layers 110 and 120, a distance between the two electrode layers 110 and 120 changes and the capacitance changes, and due to the closure of micropores in the dielectric layer when compressed, an effective dielectric constant value increases, inducing a much greater change in capacitance.

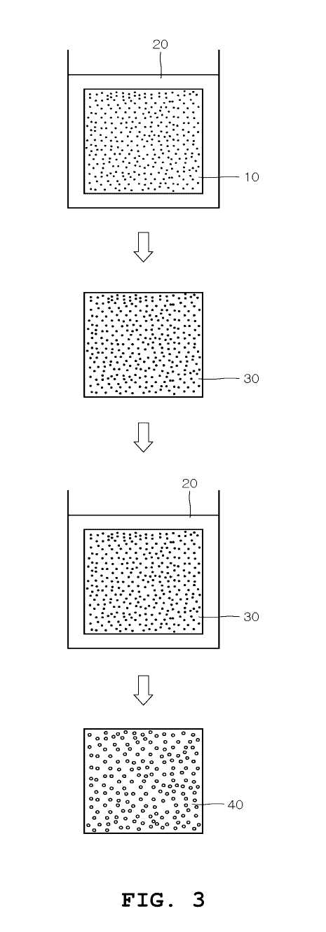

FIG. 3 illustrates an example of a process of producing the dielectric layer 130. Referring to FIG. 3, first, a liquid elastomer prepolymer solution 20 before cure is injected into a porous template 10 (for example, sugar cube) serving as a mold, followed by curing, to prepare a mixture 30 of the porous template and an elastomer. Subsequently, the porous template is dissolved in a solvent 40 (for example, water) within the prepared mixture 30 to obtain a porous elastomer 40. Although this embodiment describes that sugar cube is used as the porous template 10, this is only one example and other types of porous templates than sugar cube may be used, and the porous template may be made using a 3D printer.

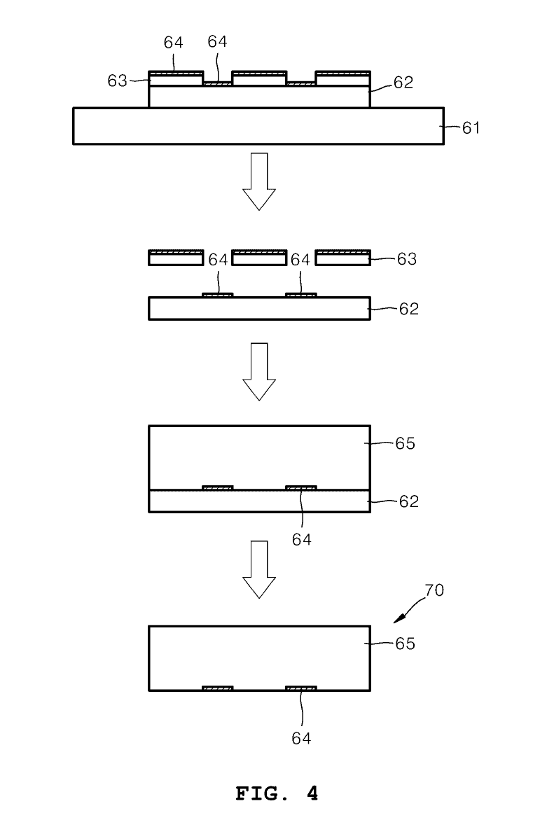

FIG. 4 illustrates an example of a process of producing the electrode layers 110 and 120. Referring to FIG. 4, first, a carbon nanotube solution is coated onto a temporary substrate 62 having a coating mask 63 attached thereto by an air spray coating method, and a solvent (for example, isopropylalcohol) of the carbon nanotube solution is vaporized using a heating plate 61 to form a carbon nanotube thin film 64 made up of carbon nanotube bundles. Subsequently, after the coating mask 63 is removed from the temporary substrate 62, a liquid elastomer prepolymer solution before cure is poured onto the temporary substrate 62 to permeate the carbon nanotube bundles in the thin film 64 and is cured, and the temporary substrate 62 is removed, to produce an electrode layer 70 having the carbon nanotube thin film 64 that forms an electrode pattern, and this electrode layer 70 can be used as the electrode layers 110 and 120 of the embodiment shown in FIGS. 1 and 2.

The dielectric layer 130 is interposed between the two electrode layers 110 and 120, and is made of a porous elastomer. A first surface (an upper surface in the drawings) of the dielectric layer 130 comes into contact with the first electrode pattern 112 of the first electrode layer 110, and a second surface (a lower surface in the drawings) of the dielectric layer 130 comes into contact with the second electrode pattern 122 of the second electrode layer 120.

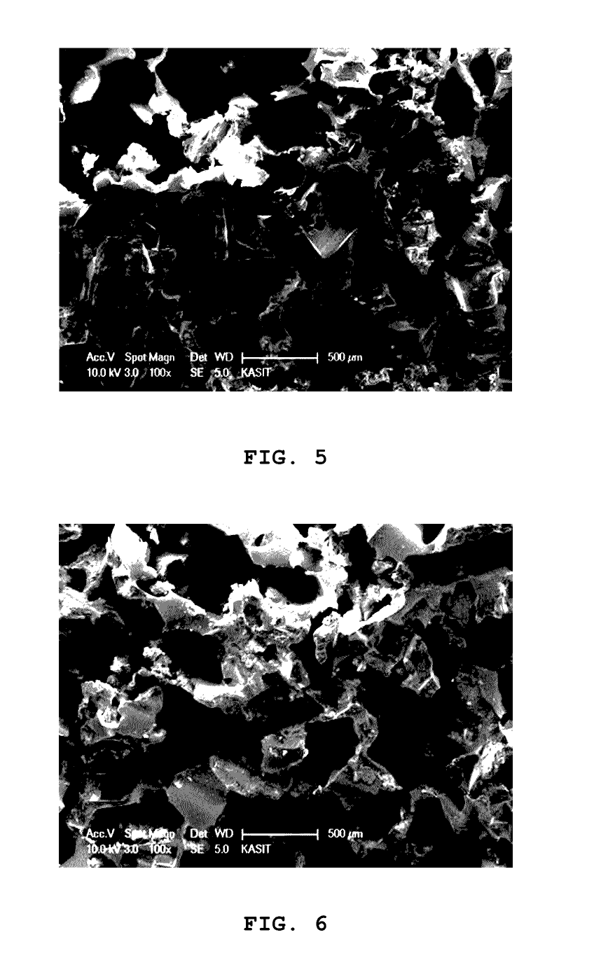

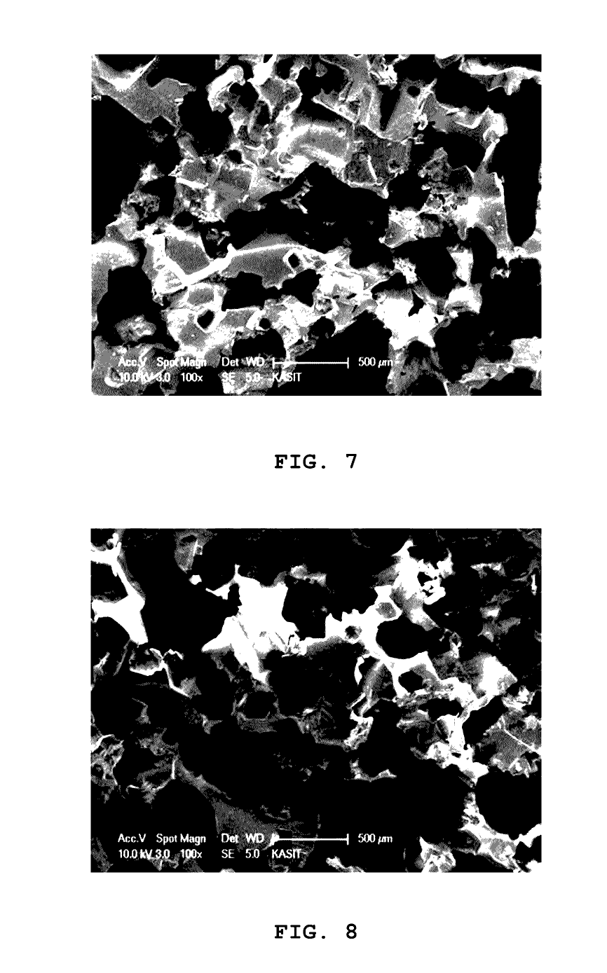

FIGS. 5 through 7 are scanning electron microscopy (SEM) images showing three cross sections of a first sample for the dielectric layer of the piezocapacitive type pressure sensor of FIG. 1, and FIGS. 8 through 10 are SEM images showing three cross sections of a second sample for the dielectric layer of the piezocapacitive type pressure sensor of FIG. 1. Although this embodiment describes that the dielectric layer has porosity of from 60% to 80%, the present disclosure is not limited thereto.

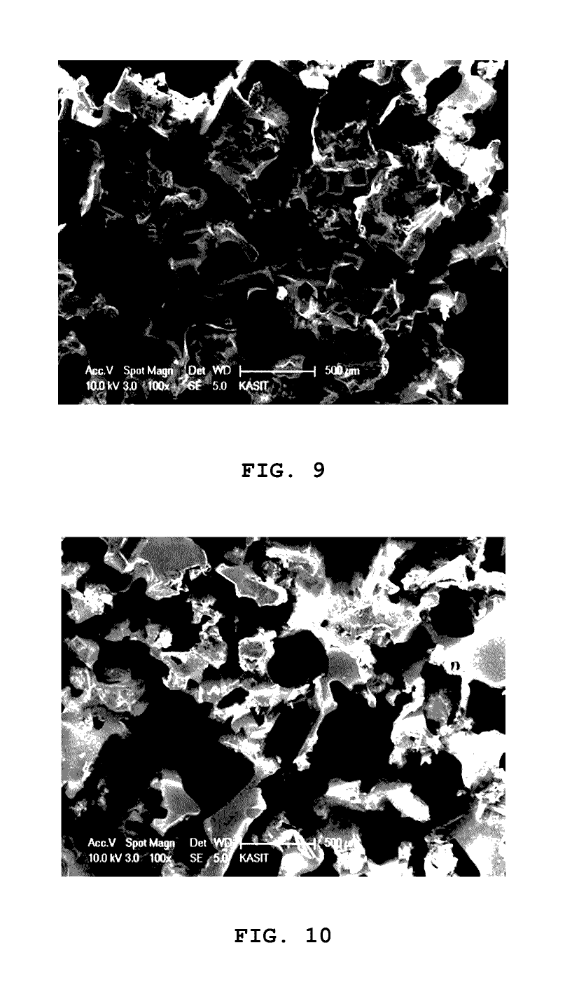

The following is a description of the pressure sensing principle of the piezocapacitive type pressure sensor 100 of FIG. 1 with reference to FIGS. 11 and 12. The dielectric layer 130 in a state of FIG. 11 under no applied external pressure is compressed as shown in FIG. 12 when the external pressure is applied, and a distance between the two electrode layers 110 and 120 becomes narrower and the magnitude of the external pressure is sensed through changes in capacitance value. In this instance, because the dielectric layer 130 is a porous elastomer having micropores 131, the dielectric layer 130 has a very high elastic strain compared to a general elastomer which is not porous, and due to this, a distance between the two electrode layers 110 and 120 greatly changes even at a smaller force, resulting in significantly improved sensitivity of the sensor. Further, as the micropores 131 are closed when compressed by the external pressure, an effective dielectric constant value increases, and as a consequence, the change of capacitance is increased and the sensitivity of the sensor is further improved.

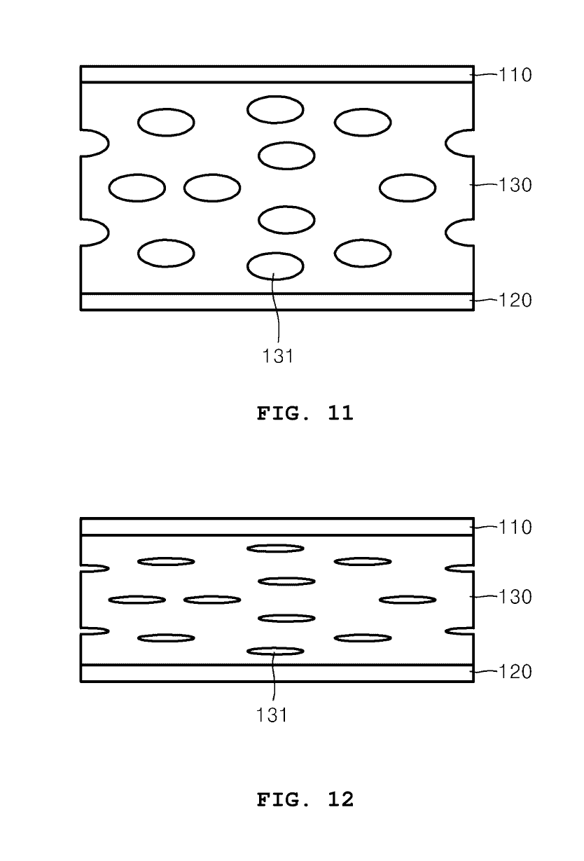

FIG. 13 is a graph showing a comparison of pressure sensing performance between the piezocapacitive type pressure sensor of FIG. 1 and a pressure sensor according to comparative example. In FIG. 13, a response curve of a pressure sensor using a general elastomer having no micropore as a dielectric layer is labelled Solid, and a response curve of the pressure sensor using the porous elastomer according to the present disclosure as a dielectric layer is labelled Porous. In the case of the porous elastomer, the curve is divided into three stages (Porous 1, Porous 2, and Porous 3) according to the pressure range of operation.

In the range of first stage Porous 1 (0 to 5 kPa), a great deformation is induced even under a low pressure due to the presence of the micropores 131 within the porous elastomer dielectric layer 130, and along with this, as the micropores 131 are closed, an elastomer area is higher than an air area and the total effective dielectric constant value of the dielectric layer 130 increases, and as a result, the sensitivity of the sensor is found very high (Sₚ₁=0.601 kPa⁻¹).

In the range of second stage Porous 2 (5 to 30 kPa), the pressure gradually increases, the micropores 131 are gradually closed, and the sensitivity of the sensor gradually reduces as well.

In the range of third stage Porous 3 (30 to 130 kPa), the pressure further increases, and when the micropores are all nearly closed, the sensitivity is lower than that of the first stage, but still the performance in terms of sensitivity is found higher about 4.8 times (Sₚ₃/Sₛ=0.077/0.016≈4.8) than the pressure sensor using a general elastomer dielectric layer. Also, when the micropores all disappear, resistance to a large external force increases and a stable sensor response is observed all the way throughout the wide range of pressure.

It can be seen that the range in which the pressure sensor using the porous elastomer dielectric layer 130 shows the highest sensitivity enables improved sensitivity that is about 37.6 times (Sₚ₁/Sₛ=0.601/0.0016≈37.6) as high as the pressure sensor using a general elastomer dielectric layer.

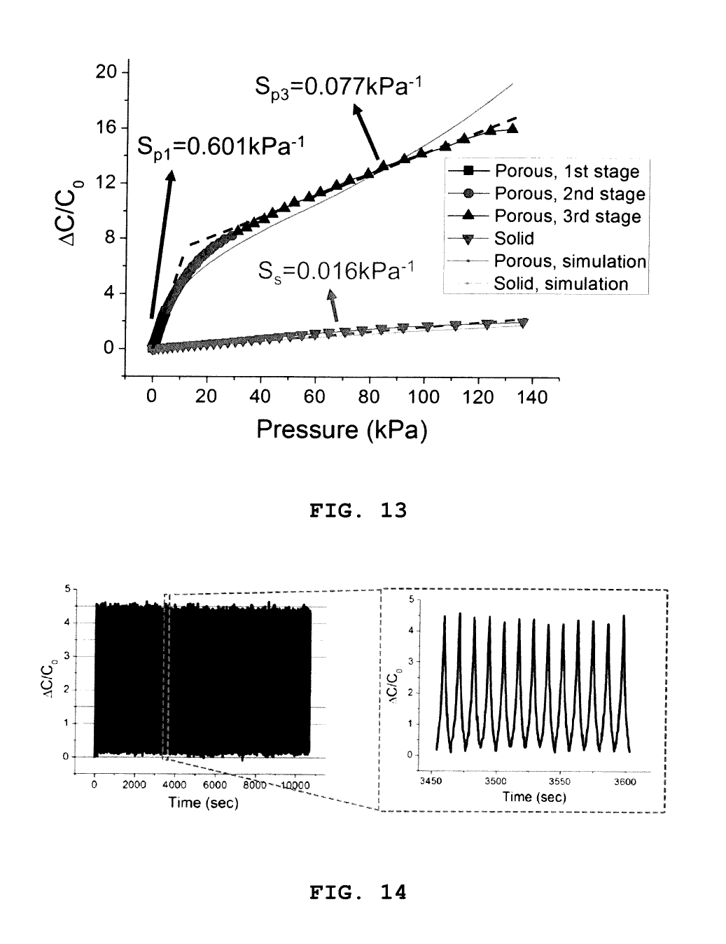

FIG. 14 is a graph showing reliability test results for the piezocapacitive type pressure sensor according to the present disclosure. In the test of FIG. 14, compression and release was repeated 1000 cycles, and as can be seen from the graph of FIG. 14, the sensor stably works.

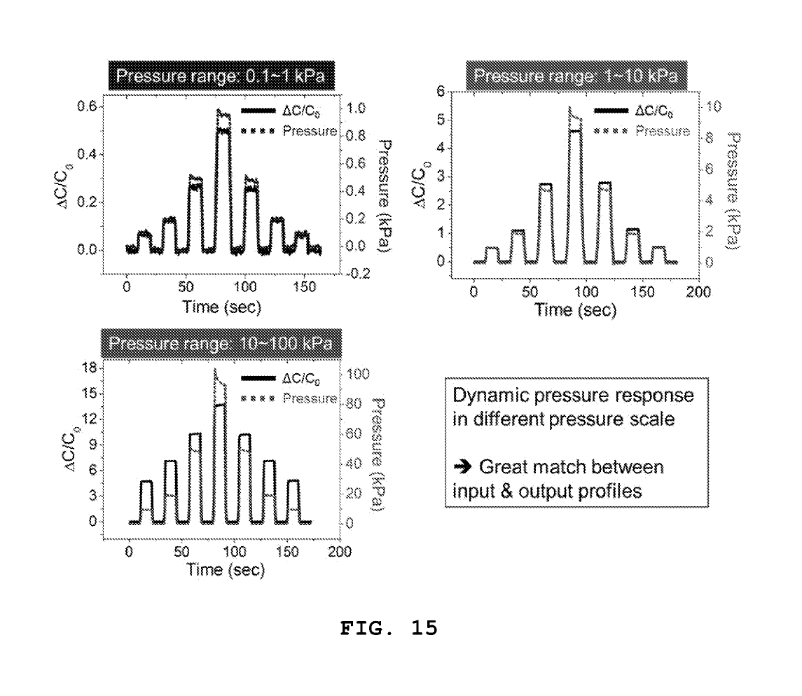

FIG. 15 is a graph showing dynamic pressure response characteristics of the piezocapacitive type pressure sensor according to the present disclosure. As shown in FIG. 15, it can be seen that a stable response as a function of pressure is observed.

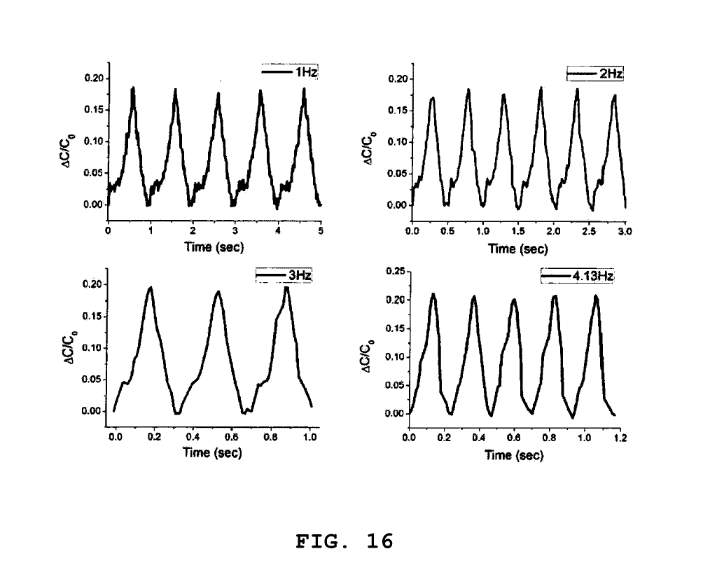

FIG. 16 is a graph showing dynamic response characteristics as a function of frequency for the piezocapacitive type pressure sensor according to the present disclosure. As shown in FIG. 16, it can be seen that a stable dynamic response to a pressure input at high frequency is observed.

The piezocapacitive type pressure sensor according to the present disclosure can be used in health care systems such as heart rate monitors, robot claws, sensor array pads, and microscale weighting systems.

While the present disclosure has been hereinabove described with respect to the embodiments, the present disclosure is not limited thereto. Various changes and modifications may be made to the embodiments without departing from the spirit and scope of the disclosure and it will be apparent to those skilled in the art that such changes and modifications fall within the present disclosure.

What is claimed is:

1. A piezocapacitive type pressure sensor, comprising:
a first electrode layer;
a second electrode layer spaced apart from the first electrode layer; and
a dielectric layer formed between the first electrode layer and the second electrode layer,
wherein the dielectric layer is made of a porous elastomer.

2. The piezocapacitive type pressure sensor according to claim 1, wherein the first electrode layer has a first base made of a flexible electrically insulating material, and a first electrode pattern made of an electrically conducting material formed on one surface of the first base, and
the second electrode layer has a second base made of a flexible electrically insulating material, and a second electrode pattern made of an electrically conducting material formed on one surface of the second base, facing the first electrode pattern.

3. The piezocapacitive type pressure sensor according to claim 2, wherein the first base and the second base are made of an elastomer.

4. The piezocapacitive type pressure sensor according to claim 2, wherein the first electrode pattern and the second electrode pattern are made up of carbon nanotube bundles as a conducting material.

5. The piezocapacitive type pressure sensor according to claim 1, wherein the dielectric layer has porosity of from 60% to 80%.
